(19) United States
(12) Patent Application Publication
(10) Pub. No.: US 2007/0127479 A1
(43) Pub. Date: Jun. 7, 2007

(54) A METHOD AND ARRANGEMENT FOR DISTRIBUTED PSEUDO-WIRE SIGNALING

(76) Inventors: David Sinicrope, Cary, NC (US); Stephen Nadas, Raleigh, NC (US); Vijay Kestur, Cary, NC (US)

Correspondence Address: ERICSSON INC., 6300 LEGACY DRIVE, M/S EVR 1-C-11, PLANO, TX, 75024, US

(21) Appl. No.: 11/275,044

(22) Filed: Dec. 5, 2005

(51) Int. Cl. H04L 12/56

(52) U.S. Cl. 370/392; 370/401

(57) ABSTRACT

The signaling for establishing a Pseudo Wire (PW) that crosses a Multiple Protocol Label Switching (MPLS) network is augmented to permit decoupling the PW processing and encapsulation from a Provider Edge (PE) or Customer Edge (CE) router. Configuration of a PW triggers the augmented PW signaling that traverses from the destination PW processing function to the origin PW processing function. The signaling may use Traffic Engineering (TE) tunnels set up a priori and, in the upstream CEs (or PEs) uses the embedded PW origin IP address to make routing decisions for the signaling packet. The rest of the signaling processing is conventional PWE3 signaling on MPLS.

### RELATED APPLICATIONS

The present invention is related to the subject matter of the following commonly assigned, co-pending U.S. patent application Ser. No. 11/197,991 entitled A METHOD AND ARRANGEMENT FOR ROUTING PSEUDO-WIRE ENCAPSULATED PACKETS, filed Aug. 5, 2005. The content of the above-referenced application is incorporated herein by reference.

### TECHNICAL FIELD

This invention relates generally to data communications over the Internet, and more particularly to a method and arrangement for transporting data packets over an IP network utilizing a Multi-Protocol Label Switching tunneling technology.

### BACKGROUND

The following table can aid the reader in determining the meaning of the several acronyms used herein.

ATM Asynchronous Transfer Mode

CE Customer Edge

CSPF Constrained Shortest Path First

DRL Destination Router Label

DS Differentiated Services

IP Internet Protocol

ILM Incoming Label Map

LDP Label Distribution Protocol

Mb Mega-bit

MPLS Multi-protocol Label Switching

NHLFE Next-hop Label Forwarding Entry

PE Provider Edge

PW Pseudo-wire

FEC Forwarding Equivalence Class

PWE3 Pseudo Wire Emulation Edge to Edge

RSVP Reservation Protocol

RSVP/TE Reservation Protocol/Traffic Engineering

SVC Switched Virtual Circuit

TE Traffic Engineering

VC Virtual Circuit

In an Internet Protocol (IP) network, packets are sent over the network with an IP header that describes a layer 3 source and destination IP address of the packets as well as other information. At an IP hop, a router looks up the IP destination address in a routing table and the route obtained is used to send the packet toward the next hop on the way to the destination. IP routing is connectionless, that is, all routers participating in the routing domain distribute routing information to each other and packets intended for a common destination may follow different individual paths through the routers toward the same destination.

A common IP network technique is “tunneling,” where one packet is encapsulated into another packet by adding a new packet header (and possibly trailer). This technique is useful, for example, for sending packets over different networking technologies and/or when a group of packets are all to receive the same treatment by the network.

Multi-protocol Label Switching (MPLS) technology, a method of tunneling, provides circuit-like properties to connectionless IP networks. MPLS is commonly used as a tunneling technology, that is, MPLS tunnels are used in a wide variety of circumstances. MPLS technology encapsulates packets with a label stack where the top-most label in the label stack determines the next routing decision instead of an IP destination address. However, it is not necessary that the encapsulated packets be IP packets. A tunneled packet, that is, the packet inside the MPLS encapsulation is not necessarily an IP packet. MPLS signaling protocols establish and clear the MPLS tunnels. In general, the signaling protocols used with MPLS are Reservation Protocol/Traffic Engineering (RSVP/TE), which is a variation of the Reservation Protocol (RSVP) and Label Distribution Protocol (LDP). Added services may also be signaled, such as alternate tunnel paths.

Traffic engineering (TE) is concerned with optimizing the use of the existing capacity of a network. For example, overloaded links are relieved of traffic pressure while underused links carry more of the traffic load. TE is also used to direct traffic with specific Quality of Service (QoS) needs toward network resources, i.e., nodes and links, which can support those needs. If needed, network resources are reserved to help guarantee the QoS requested. RSVP/TE and MPLS tunnels are commonly applied in TE solutions.

Modern IP Traffic Engineering solutions incorporate Differentiated Services (DS) and combine these with MPLS (DS aware MPLS). This combination provides mechanisms for tracking available link bandwidths in several classes of service, which in turn, enables constraint based routing (also called constrained, shortest path first (CSPF) routing). CSPF finds paths through the network where sufficient bandwidth exists in the desired class. The MPLS tunnel may then be established along these paths. Thus, TE can be applied to different classes of traffic and the MPLS tunnels support this by carrying traffic of one or more classes of service.

Routers in the telecommunication network are sometimes classified as provider edge (PE) and customer edge (CE) depending on whether the Internet service provider or customer operates the routers. In a traditional MPLS paradigm, PE routers provide MPLS functionality and run MPLS signaling protocols while CE routers are assumed to not have MPLS functionality. This assumption is made for two reasons. The first is backward compatibility, that is, the providers wished to use more sophisticated MPLS/TE solutions in their own networks and did not want to require their customers to change their CE routers. The second reason is to support more efficient scaling; the PE's could be richly meshed and this network topology could support many more CE routers than PE routers. This paradigm assumes that MPLS is used in the core but that it is not needed in the customer access networks.

Pseudo Wire Emulation Edge to Edge (PWE3) technology provides Layer 1 and Layer 2 specific emulation services over packet switched network (PSN) tunnels. Associated with PWE3 is the pseudo-wire control protocol (PWE3 CTL), which is based on Label Distribution Protocol (LDP). PWE3 allows a provider to offer different Layer 1 and Layer 2 services, i.e., an E1 circuit, an ATM VCC, a 100 Mb Ethernet and a Frame Relay PVC may all be offered over a common IP/MPLS core infrastructure. These are referred to as a TDM pseudo-wire, an ATM VCC pseudo-wire, an Ethernet pseudo-wire and a Frame Relay pseudo-wire respectively. This is accomplished by the PWE3 pre-pending a pseudo-wire header, which identifies the pseudo-wire over which the encapsulated data is to be transported, which in conjunction with the pseudo-wire signaling allows the remote end points to understand how the particular Layer 1 or Layer 2 encapsulation details are to be handled.

PWE3 relies on tunneling technology to transport the PWs across the MPLS/IP core. MPLS is a popular choice for this transport because of the possibility of using Diffserv aware MPLS TE tunnels, so that PWs with different characteristics can be aggregated into MPLS tunnels that support an appropriate class of service. When PWE3 uses MPLS tunnels, it also assumes the MPLS paradigm that MPLS is used in the core but is not needed in the customer access networks.

As stated above, a PE router is typically the device that offers the Layer 1 or Layer 2 services to a like customer premises device. This implies that the provider is offering several Layer 1 or Layer 2 emulated services and that the provider is managing the resultant complexity. The equipment cost to enhance a PE router to provide the speeds and feeds for each service is considerable. Each PE router used to offer the Layer 1 or 2 services must be enhanced. Typically additional PE routers must be installed to simply obtain port density needed for a service offering and the routing capacity of these PE routers may not be fully utilized.

In its current usage PWE3 capability is typically concentrated in a provider edge (PE) router. These routers are then used to provide Layer 2 and Layer 1 services via native attachment media. (e.g., the PE router provides ATM service using an ATM port on the PE router. The ATM traffic is then encapsulated in PWE3 and transported). Typical PE routers do not have the space for the volume and types of native interfaces that would be needed for cost effective service deployment. Generally, a second router must be added to get additional interfaces before the forwarding capacity of the first is fully utilized. One solution is to separate the router from the PWE3 function. However, if the PWE3 system is to make decisions about which route PWE3 packets are to take, then routing information and MPLS signaling must be available.

When this approach is employed, each PWE3 system must run PWE3 control signaling and the PWE3 system must set up PWE3 signaling sessions to all the other PWE3 systems. This action induces a scaling problem in that if the number of PW systems is n, the number of PWE3 signaling sessions approaches “n squared.” Complexity and cost are also added to the PW encapsulation systems. What is needed is a method and system for distributing the PWE3 control signaling between the routers and the PWE3 systems such that the PWE3 signaling sessions are more scalable.

### SUMMARY

Enhanced cost efficiency and scalability is gained when a router is separate from the PWE3 function and one router serves many lower cost PW encapsulation systems. Native interfaces and PW encapsulation functions are separated from the router function increasing the number of interfaces that one router can handle. The cost of a router system is magnitudes greater than a PW system and the PW system provides greater cost effectiveness and reduces the edge router requirements of the network. Separating the functions also allows the router capacity to be increased, independent of the PW function, providing better utilization for the router investment.

A method of distributing the PWE3 signaling is presented which allows a PW to be signaled in segments between two PWE3 systems and via one or more routers. The distributed PWE3 signaling uses locally configured information as well as routing information to progress the PWE3 control messages (via an unsolicited Label Map message) segment by segment from PW destination to PW origin. At each PW segment endpoint the equipment determines where and how to progress the PW signaling message to complete the next segment. The resulting PW segments are then “stitched” together to form a completed PW.

By signaling the PWs in multiple segments, routing and tunnel information is localized to the nodes that require it. This approach also results in localized and fewer signaling sessions, thus improving scalability and management of the PWs.

### BRIEF DESCRIPTION OF THE DRAWINGS

For a more complete understanding of the present invention, reference is made to the following detailed description of the invention, taken in conjunction with the accompanying drawings. Corresponding numerals and symbols in the figures refer to corresponding parts in the detailed description unless otherwise indicated.

FIG. 1a depicts a high-level block diagram of a Multi-Protocol Label Switching network;

FIG. 1b illustrates a high-level block diagram of the MPLS network wherein increasing the number of PE routers has increased forwarding capacity;

FIG. 1c depicts a high-level block diagram of an MPLS network in which a preferred embodiment of the present invention may be implemented;

FIG. 1d illustrates of the advantages of the MPLS network when forwarding capacity has been increased in accordance with an embodiment of the present invention;

FIG. 2 depicts the configuration and signaling steps needed to set up the a pseudo-wire in the preferred embodiment of the present invention;

### DETAILED DESCRIPTION OF A PREFERRED EMBODIMENT

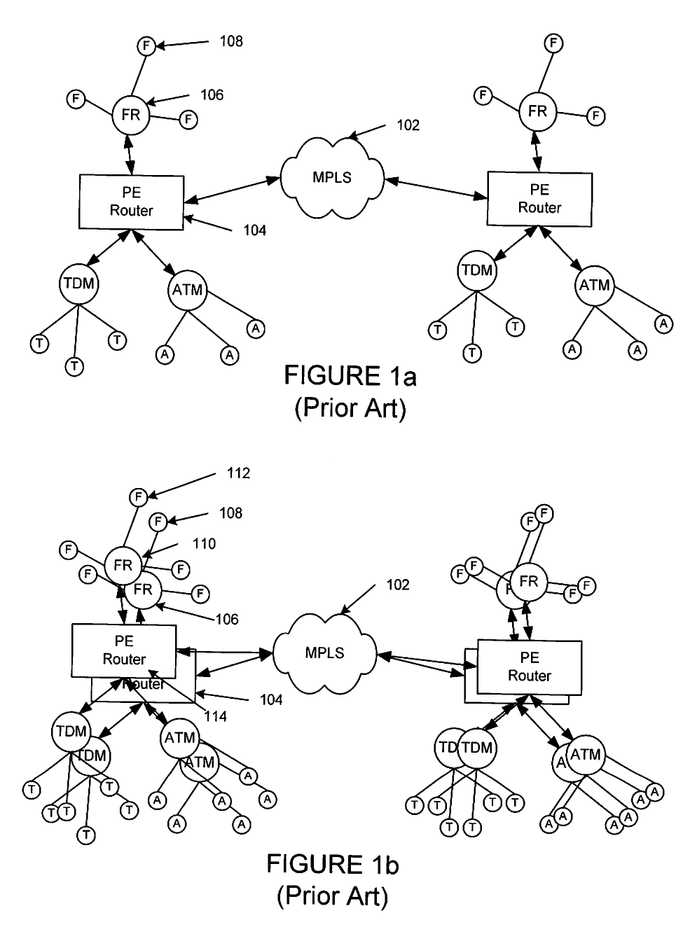

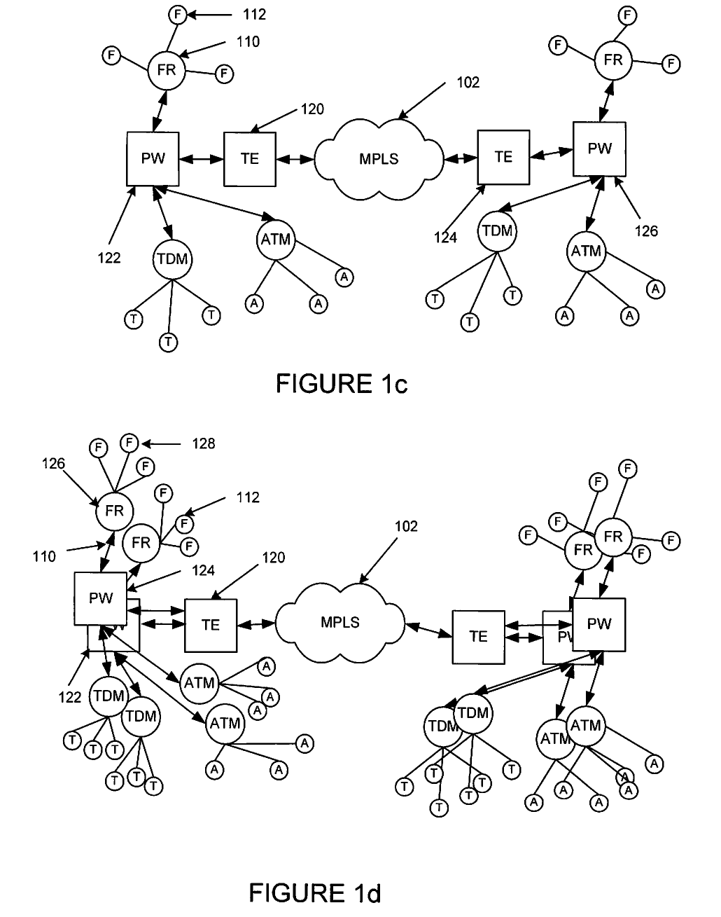

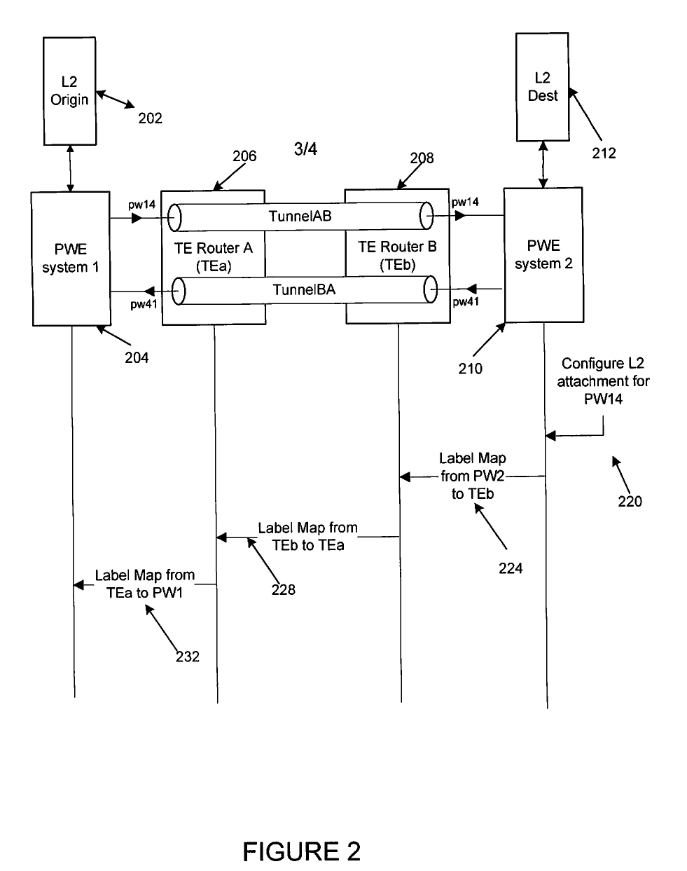

FIGS. 1-2, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged Pseudo-wire system for transporting data across a Multi-Protocol Label Switching network.

FIG. 1a depicts a high-level block diagram of Multi-Protocol Label Switching network 102. For convenience and ease of explanation, only the Frame Relay system is numbered. The other depicted data sources and data ports transfer data to the router in the same manner as the Frame Relay function. Currently, data arrives at Provider Edge (PE) router 104 from either or all of Frame Relay (FR) 108 data sources, Asynchronous Transfer Mode (ATM) or Time Division Multiplex (TDM). Data common to a data type such as frame relay data 108 is directed to a Frame Relay port 106 in PE router 104. A Pseudo-wire label is attached by a Pseudo-Wire system (not shown), originating in PE router 104, to the data for routing through a Traffic Engineered (TE) tunnel (not shown). The PW function and the Traffic Engineering function is an integral part of PE router 104. Note that a Customer Edge (CE) router (not shown) can handle the functions of the PE router also. Only the “left” side of the block diagram of the network is provided with reference numbers, as the “right” side of the network is a mirror image of the left side and functions in the same manner as the left side.

FIG. 1b illustrates a high-level block diagram of the MPLS network wherein forwarding capacity has been increased. The additional blocks are added to show how equipment has to be increased in order to increase capacity of the current system. As noted earlier, in order to increase capacity for more PW traffic, more PE routers have to be added. PE router 114 has been added to MPLS 102 to increase TDM, ATM and Frame Relay data input capacity. In order to simplify the illustration, only the addition of Frame Relay input 110 and Frame Relay data 112 are labeled and as illustrated both sides of the network require a doubling of equipment.

FIG. 1c depicts a high-level block diagram of an MPLS network in which a preferred embodiment of the present invention may be implemented. In the present invention, PW function 122 is separated from TE function 120 that provides traffic engineered PSN tunnels (not shown); both PW function 122 and TE function 120 are independent of each other. Frame Relay data 112 is consolidated at Frame Relay input 110 to PW function 122. Pseudo-wires are set up between the PWE3 encapsulating input (PW function 122) and PWE3 decapsulating output (PW function 126) via a tunnel (not shown) between TE 120 and TE 124. The encapsulated data is sent to TE 120 over the Pseudo-wire between PW 122 and PW 126. The details of the steps to setup the pseudo-wire when the PW function is decoupled from the CE router function, and the TE function in particular data are described in more detail below.

FIG. 1d illustrates a high-level block diagram of the MPLS network when forwarding capacity has been increased in accordance with an embodiment of the present invention. In the prior art, when capacity needs to be increased more equipment, i.e., a router, is added. In the present invention PW function 124 is added instead of an additional PE router. PW function 124 is magnitudes cheaper than a router. For instance, in the present invention where the PW function is a single card, data source 128 would transfer Frame Relay data to Frame Relay input 126 in PW function 124 (PW function 124 is capable of being provided on a single circuit board, or “blade”). Multiple PW blades like PW 122 and PW 124 may be utilized at a fraction of the cost of an edge router and may be added as the need for capacity increases.

Reference is now made to FIG. 2 wherein a process describing the configuration and signaling steps to set up a pseudo-wire (PW14) are described in conjunction with a high-level block diagram of an embodiment of the present invention. All PW systems connected to the same TE router share a common label space.

L2 attachment is configured in PWE system 2 (PWE 210) and L2 Destination 220 (step 220). Pseudo-wire 14 (PW14) is configured at PWE 210, wherein PWE 210 derives the PW forwarding equivalence class (PW FEC), assigns a PW label and extracts the PW Origin IP address to form a label map message, which includes FEC elements that carry this information.

Assuming there is a route to the remote PWE system (PWE 204), PWE 210 finds an LDP session for a next hop associated with the PW14 destination IP address and if there is no route or no session, an error message (not shown) is generated for the operator and the process returns to a state where it awaits new configuration actions or signaling messages. In the normal (non-error) case PWE 210 then sends a label map message (step 224) to an upstream LDP peer, TE Router B (TEb 208). Finally, PWE 210 associates the PW label with the configured Layer 2 attachment circuit.

The label map message arrives at TEb 208 and assuming that there is a route to the remote PWE system 1 (PWE 204), TEb 208 determines the LDP session for the next hop associated with the PW destination IP address. If there is no route or session, an error message (not shown) is generated and sent to PWE system 2; the process returns to a state where it awaits new configuration actions or a new signaling message. If TEb determines that it owns the PW destination IP address (not the case in this example) see below the description for processing at PWE 204. Otherwise, TEb 208 sends a label map message to its upstream LDP peer, TE router A (TEa 206). Then, TEb 208 compares the destination PW IP address with the LDP peer address and if they are not the same, determines that an ILM entry needs to be downloaded. TEb 208 sets up ILM/NHLFE (MPLS hardware) structures such that packets with the pseudo-wire label for PW14 are sent to PWE 208. Note that the Tunnel label for TunnelAB was removed from the label stack according to normal MPLS tunnel processing.

Similarly, the label map message arrives at TEa 206 and assuming that there is a route to PWE 204, TEa 206 determines an LDP session for the next hop associated with the PW14 destination IP address. If there is no route or no session, an error (not shown) is generated and sent to TEb 208. If TEa determines that it “owns” the PW destination IP address (not the case in this example), see below the description for processing at PWE 204 Otherwise, TEa 206 sends a label map message to its upstream LDP peer, PWE 204. TEa 206 compares the destination PW IP address with the LDP peer address and if they are the same, determines that a destination router label (DRL) will be used (see co-pending application Ser. No. 11/197,991). Note that its ILM/NHLFE (MPLS hardware) structures were setup a priori such that the DRL AB label (routing from TEa 206 to TEb 208) will be removed from the label stack, the Tunnel AB label will be pushed on the label stack and the packets with the Tunnel AB label are sent to TE router B.

Finally, the label map message arrives at PWE 204 which determines that PWE 204 owns the PW destination IP address, and PWE 204 associates the PW label in the label map message with the specific L2 attachment (i.e. when a packet is sent for this pseudo-wire, the PW label will be pushed onto the packet) and PWE 204 uses the PW structures (set up a priori) such that the DRL label will be pushed onto the label stack and the packets with the DRL label are sent to TEa 206.

When traffic is sent on PW14 from PWE 204 to PWE 210, the following events occur: PWE 204 creates a PW PDU, pre-pends the DRL to the PDU and sends the modified packet to TEa 206. TEa 206 removes the DRL from the label stack, adds MPLS label(s) for “tunnelAB” and sends the MPLS packet to TEb 208. When this packet arrives at TEb 208, TEb 208 de-capsulates the MPLS label stack and sends the packet to PWE 210. PWE 210 uses the PW label to associate the packet with the specific attachment circuit and provide the proper PW processing.

Note that in the disclosed system, data may originate at either end of the depicted MPLS system. In other words, a symmetric arrangement accounts for configuring and signaling the PW41 in the opposite direction. Thus, pseudo-wires are established in both directions enabling data flow across the MPLS network and PW systems. In one instance PWE 210 may send data to PWE system 204 for delivery to a particular address and in the next instance receive data from PWE 204 for delivery for a connected destination.

The present invention has advantages over the current state of the art. The present invention scales the MPLS tunnels according to the number of TE routers, which is smaller than the number of PWE systems. Solution designers are free to place the PWE3 processing near the L2 sources and decouple the PW processing from the TE router. More cost effective use of the TE router is accomplished by allowing more interfaces and types of interfaces per TE router and the present invention uses the TE router's forwarding capacity more efficiently.

While the invention has been particularly shown and described with reference to a preferred embodiment, it will be understood by those skilled in the art that various changes in form and detail may be made therein without departing from the spirit and scope of the invention.

What is claimed:

1. A method for transporting Pseudo Wire Emulation Edge to Edge (PWE3) signaling information in a Multi-protocol Label Switching (MPLS)/Internet Protocol (IP) network having separated Pseudo Wire Emulator (PWE) functions, Provider Edge or Customer Edge (PE or CE) Traffic Engineering (TE) routers and a TE tunnel established between any two TE routers, the method comprising the steps of:
configuring a Layer 2 (L2) attachment for a specific pseudo wire at a destination PWE and L2;
forming a label map message including a pseudo-wire forwarding equivalence class (PW FEC), wherein the PW FEC includes a PW origin IP address;
finding an LDP session for a next hop toward the PW origin that is associated with the PW origin IP address;
sending the label map message on the next hop to an upstream peer from the destination PWE, wherein PW signaling is divided into multiple segments, the segments being measured between the PW origin IP address and the destination PWE.

2. The method of claim 1, wherein a PW label is associated with the configured L2 attachment.

3. The method of claim 1, wherein the PW signaling progresses opposite traffic flow.

4. The method of claim 1, further comprising the steps of:
receiving the label map message at the upstream peer;
extracting the PW origin IP address;
finding the LDP session and a next upstream peer; and
sending a new label map message to the next upstream peer.

5. The method of claim 4, wherein if the PW origin IP address is not the same as the LDP session peer IP address, setting up a MPLS incoming label map (ILM) and next hop label forwarding entry (NHFLE) and associating the PW labeled traffic for sending to the downstream peer.

6. The method of claim 4, further comprising the steps of:
receiving the new label map message at the next upstream peer;
extracting the PW origin address;
determining that the next upstream peer is the PW origin address;
associating the PW label with the L2 attachment; and
encapsulating L2 traffic for the L2 attachment.

7. The method of claim 1, wherein data associated with the PWE3 signaling information is one or more of Frame Relay, Ethernet, ATM, TDM, PPP and other PWs.

8. A system for transporting Pseudo Wire Emulation Edge to Edge (PWE3) signaling information in a Multi-protocol Label Switching (MPLS)/Internet Protocol (IP) network having separated Pseudo Wire Emulator (PWE) functions, Provider Edge or Customer Edge (PE or CE) Traffic Engineering (TE) routers and a TE tunnel established between any two TE routers, the system comprising:
means for configuring a Layer 2 (L2) attachment for a specific pseudo wire at a destination PWE and L2;
means for forming a label map message including a pseudo-wire forwarding equivalence class (PW FEC), wherein the PW FEC includes a PW origin IP address;
means for finding an LDP session for a next hop toward the PW origin that is associated with the PW origin IP address;
means for sending the label map message on the next hop to an upstream peer from the destination PWE, wherein PW signaling is divided into multiple segments, the segments being measured between the PW origin IP address and the destination PWE.

9. The system of claim 8, wherein a PW label is associated with the configured L2 attachment.

10. The system of claim 8, wherein the PW signaling progresses opposite traffic flow.

11. The system of claim 8, further comprising:
means for receiving the label map message at the upstream peer;
means for extracting the PW origin IP address;
means for finding the LDP session and a next upstream peer; and
means for sending a new label map message to the next upstream peer.

12. The system of claim 11, wherein if the PW origin IP address is not the same as the LDP session peer IP address, the system further comprising
means for setting up a MPLS incoming label map (ILM) and next hop label forwarding entry (NHFLE) and associating the PW labeled traffic for sending to the downstream peer.

13. The system of claim 11, further comprising:
receiver means for receiving the new label map message at the next upstream peer;
extraction means for extracting the PW origin address;
means for determining that the next upstream peer is the PW origin address;
means for associating the PW label with the L2 attachment; and
encapsulation means for encapsulating L2 traffic for the L2 attachment.

14. The system of claim 8, wherein data associated with the PWE3 signaling information is one or more of Frame Relay, Ethernet, ATM, TDM, PPP and other PWs.
